(19) United States
(12) Patent Application Publication
(10) Pub. No.: US 2024/0000049 A1
(43) Pub. Date: Jan. 4, 2024

(54) Dynasty/Aquatica

(71) Applicant: Christopher Demetrius Echols, Crown Point, IN (US)

(72) Inventor: Christopher Demetrius Echols, Crown Point, IN (US)

(21) Appl. No.: 17/712,666

(22) Filed: Jun. 30, 2022

(51) Int. Cl. A01K 63/00; A01K 63/04

(52) U.S. Cl. CPC A01K 63/006; A01K 63/045; B05B 17/08

(57) ABSTRACT

A filtration system structure with a front face such as an operating face, including elements of the user interface of the filtration system is provided. A major part of the front face is concave so that the front face is retracted and thereby protected from being damaged.

### FIELD

The present application relates to a water fountain with a filtration system in particular the font face that is an operating face that is provided for a user to interact with.

### BACKGROUND

Electronic fountain device, such as drinking fountain water fountain are products that sometimes are used for drinking water or decorative scenery therefore most of them are not very attractive and appealing that use a filter cartridge that people will constantly have to buy and can get expensive at times. The materials used for the embodiment structure of this such device is clear acrylic plexiglass that can with stand hot and cold temperatures and if scratched can easily be buffed out. The acrylic plexiglass structure is lightweight and easy to carry around. It's very strong and durable, it can withstand if it is dropped unlike glass which would shatter that Is why this material is the best. It gives the ability to see through it and when light shines through it and gives it a unique and stylish look.

### SUMMARY

providing an acrylic plexiglass water fountain having a rectangular base will reduce any damage that may be caused to the filtration system compartment.

The disclosed exemplary embodiment provides a water fountain in which at least a major portion of the front face is curved.

In one embodiment the base has a first extent a second extend the first extend maybe longer than that second extend the operating structure is square in the direction of the first extend.

In the embodiment the rear structure panel is an extended surface that extends from edge of the base structure to the left and right side in the direction of the first extent.

In another embodiment the housing of the filtration system comprises a flat panel with a curve in edge to the rear panel face.

The water fountain for pets like your cat and dog there are three different sizes for pets big or small. It comes small medium and large. The fountain has a filtration system as well, and holds many gallons of water depending on the size it can hold 20, 30, 40, gallons of water depending on the sizes, keeps the water clean and fresh, Do to the filtration system of my design, it's good for keeping your pets hydrated because running water make your pets want to drink it and in their mine it means fresh water which it is, and the sound of trinkling water can be intriguing for the pets and you alone such as the look of it looks like it is just a brilliant way of having an in-house waterfall because of the Style, it makes it suitable for indoors and outdoors whatever the person prefers who wouldn't like a waterfall in their home it's stylish and does not look like it's a water fountain for pets also with the fountain, you can decorate it, it also comes with a decorative back ground as you can see in the picture it comes with a water pump that can pump 75 gallons in seconds which will keep the waterfall part with A continuous flow, it lights up in several different colors maybe more it has a light feature as you can see the edges are smooth and buffed for a smooth finish. But overall I think this invention is a great idea and I think a lot of people will love it especially for the pet lovers it also can be used as a fish tank for pets as well I hope you can agree with me, that this is a great idea, This idea came to me while I was in my basement/man cave LOL and I had one of those little cheap pet fountain that didn't hold much water and you have to constantly fill it up I have a dog and two cats and with the cats, it would last quite a while but when my dog came to drink the water, the water would be gone within seconds after she drinks it, So I thought about a nicer fountain that holds more water, more decorative, and more stylish and doesn't necessarily look like a fountain for pets so I came up with this idea in plexiglass it's strong and pretty and you can see through it and when light shines through it, it looks beautiful.

The Aquatica is a variation from the dynasty specifically designed for aquatic fish. I came up with the Aquatica fish tank because I know that some people always wanted a fish tank but the hassle of buying extra components that you need for a successful fish tank, my design cuts that expense in half allows you to buy a Fish tank with a cool unique design with the built-in filtration system permanently attached directly behind the tank with a beautiful built-in waterfall. This makes it instantly ready to use all it needs to be added is sponges and media to start the filtration cycle. The Aquatica can be used for freshwater or saltwater fish.

Further objects features, and advantages and properties of device according to this present application will become apparent from the detailed description

### BRIEF DESCRIPTION OF THE DRAWING

In the following detailed portion of the present description, the teachings of the present application will be explained in more detail with reference to the example embodiments shown in the drawings, in which

FIG. 1 is an isometric view of a device according to a first embodiment,

FIG. 2 is an isometric view of a device according to a second embodiment, and

FIG. 3 is an isometric view of a device according to a third embodiment, and

FIG. 4 is an isometric view of a device according to a fourth embodiment.

### DETAILED DESCRIPTION

In the following detailed description, the device according to the teachings for this application in the form of a fountain/water fountain will be described by the embodiments. It should be noted that although only a water fountain is described the teachings of this application the filtration systems can also be used in any other embodied structure containing water such as aquatic fish tanks like freshwater or saltwater fish, decorative water fountains, recreational water fountains and or drinking fountain for household pets and other electronic fountain offering access to information.

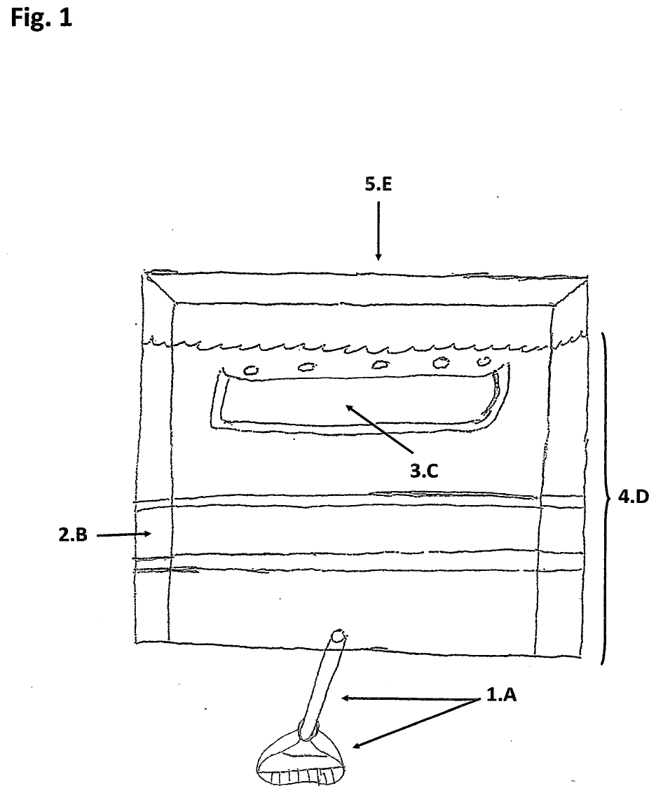

A first embodiment of the filtration system structure (4.D) is illustrated in FIG. 1. The reservoir embodiment (4. D) comprises a housing (3. C) with a front face panel with spout that extends outward at a 30 degrees angle (2.8) that is provided with media components such as 2 filter sponges, larva rocks, activated carbon (1.A), a hose and electric water pump. (1.A) is an operating component hose that includes one important element water (2.B), water rises to and through the media components (4.D) continue rising within reservoir structure to the top (3.C) the filtration is complete, water then exits spout to return to place of origin (5.E) the cover component is for protection to keep dust and debris out of filtration embodiment.

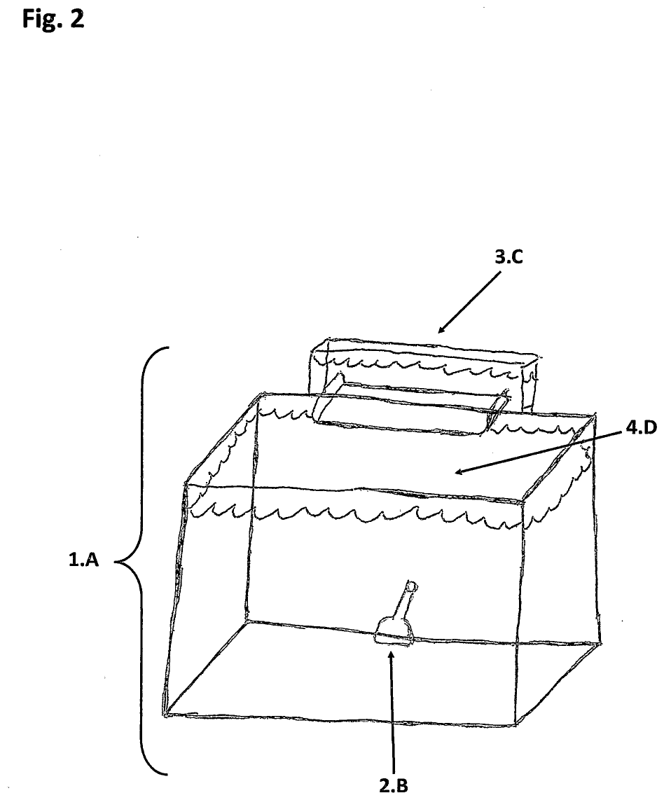

A second embodiment of the aquatic fish tank structure (variation) (1.A) is illustrated in FIG. 2. Consist of 5 flat surface panel side, base panel, right panel, left panel, front panel, rear panel (1.A) comprises a housing for water, aquatic fish, which is a five-side flat panel surface that forms a rectangular shape, can vary in shape and size (2.B) water pump, for filtration system that pumps water from aquarium tank into the filtration media reservoir, shown in FIG. 1. and there also can be a siphon hose or pipe to siphon water from the tank to reservoir. (3.C) is the location of the filtration system media behind the rear panel permanently attached. (4.D) The location of reservoir embodiment and tube where the water can be withdrawn from the tank (4.D) above the rear panel is the spout that returns the filtrated water back to the point of origin and the process repeats.

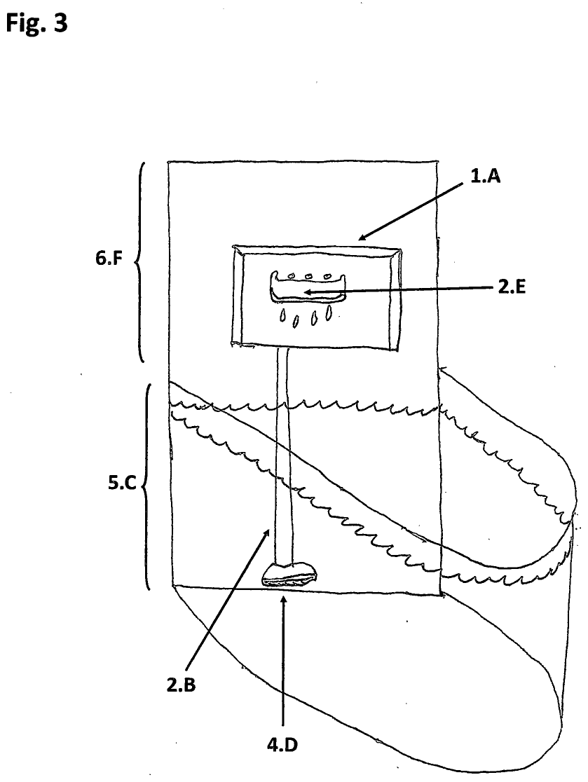

A third embodiment of the fountain aquarium (variation) (1.A) is illustrated in FIG. 3. (1.A) The Location of reservoir for filtration to begin water fill the reservoir then goes through filtration components shown in (FIG. 1) (2.B) Here is the tube that begins in the base of tank that carries the water up into the filtration housing (3.C) base of the tank which will vary in different sizes that is concave to contain water. (4.D) water pump drives water through tube and to the filtration system. (5.E) When filtration is complete water returns to the tank by the spout in front of the filtration embodiment (6.F) that is permanently attached to the front panel, but can be attached to the rear

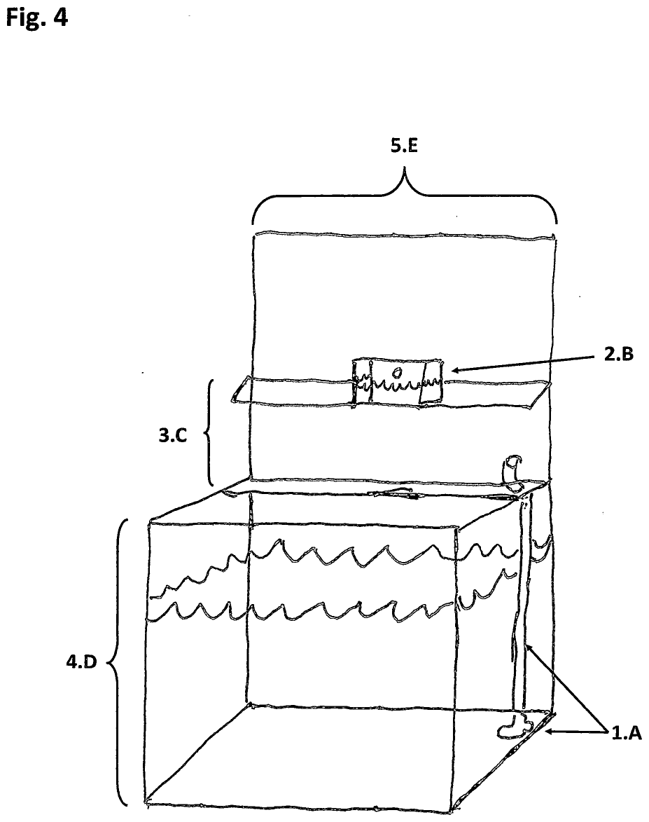

A fourth embodiment of the water fountain (1.A) is illustrated in FIG. 4. The water pump and tube (1.A) water pump Begins at the base of the tank, that push the water up the tube into the filtration reservoir (shown in FIG. 1) the water flows Through the tube around the bottom shelf through the lower right area of the rear panel and into the reservoir to begin the filtration process (2.B) the location of reservoir filtration system to begin the tube comes out from behind the rear panel into the filtration embodiment water fills the reservoir through the filter media and return through the spout to point of origin when filtration is complete. (3.C) shelves for decorations and filtration system the location of the filtration system is on the highest top shelve permanently attached. the two shelves are permanently attached to the rear panel and top base tank edges (4.D) the base of the tank which varies in size which consist of five panels front panel, left panel, right panel, base panel, and rear panel (5.E) rear panel that extends from the base as one solid piece.

The embodiment of all four FIG. 1.2.3.4. of the entire structure are made from clear acrylic plexiglass materials that is stronger than glass not easily to be broken having some scratch resistant coating on them. The teachings of this present application it's presented in clear acrylic plexiglass material and can be in colored acrylic plexiglass for instance red, blue, green, and so on.

The various aspect of what is described above can be used along various combinations. it should be noted that teachings of this application are not limited to the use in water fountain structure, such as aquatic fish tanks be like freshwater or saltwater fish tanks, decorative water fountain, recreational water fountains, and or drinking fountains for household pets and other electronic fountains or that a like.

The teaching of the present application has numerous advantages. different embodiments or implementations may yield one or more of the following advantages. It should Be noted that this is not exhaustive list and there may be other advantages which are not described herein. For example, one advantage of the teachings of this application is it provides for a device with a reusable and washable filtration system that is less vulnerable to being damaged or scratched. Another advantage of the present invention is it provides for ergonomic front face shape. It is yet another advantage of the present invention that it provides for a device with a unique style and ergonomic housing shape.

Although the teachings of this present application have been described in detail for purpose of illustration, it is understood that such details are solely for the purpose, and variations can be made therein by those skilled in the art without departing from the scope of the teachings of this application. for example, the device has been described with a housing that is a substantially triangular, rectangular, concave, and flat panel shape, but it is understood that the panel does not need to be triangular, rectangular, concave, and flat panels the outline of the housing could have any other suitable shape that is used in these kinds of fountains. Furthermore, the device has been described with a housing that is in one piece, but it should be understood that the teaching can also be applied to devices with other purposes such as known from aquariums tanks, recreational water fountains, and or drinking fountains that are small, medium, or large, in size.

For example, although the teachings of the present application have been described in terms of a water fountain it should be appreciated that the teachings of the present application may also be applied to other types of electronic fountains or any structure containing water and that alike. it should also be noted that there are many alternative ways of implementing the methods and apparatuses of the teachings of the present application.

features described in the preceding description may be used at combinations other than the combinations explicitly described.

Whilst endeavoring in the foregoing specifications to draw attention to those features of the invention believed to be of particular importance it should be understood that the application claims protection in respect of any patentable features or combinations of features herein before referred to and or/shown in the drawings whether or not particular emphasis has been placed thereon.

The term “comprising” as used in the claim does not exclude other elements or steps. The term “a” or “an” as used in the claims does not exclude a plurality. A unit or other means may fulfill the functions of several units or means recited in the claim.

1. An acrylic plexiglass water fountain that consists of a waterfall spout, washable reusable filtration system, acrylic plexiglass spout connected to the filtration media, wherein each spout has a slot for water to exit.

2. Water fountain according to claim 1, wherein the filtration media at the base there is a water pump, that pumps the water to and through the media filtration system.

3. A water fountain according to claim 2, wherein the operating face there is a shelf for decorative items on each side of the filtration system, at the top of the filtration system is a lid that can also be used as a shelf and to keep out dust and debris out.

4. A water fountain according to claim 3, wherein the entire structure is made of clear acrylic plexiglass that extends throughout from edge to edge, also can be made with multi color acrylic plexiglass.

5. A water fountain according to claim 1, wherein the base of the structure consists of the reservoir where body of water rest within a curvy square shape, which can vary in shape and size.

6. A water fountain according to claim 1, wherein the front face is an operating face where interact takes place.

7. A water fountain according to claim 1, wherein the operating face shelves are present where the user interacts with structure.

8. A water fountain according to claim 1, wherein the operation of the filtration system is permanently fixed to the backboard to complete the seal compartment of the filtration system.

9. A water fountain according to claim 8, where in the filtration system can also be permanently attached to the front or back of backboard panel of any tank structure holding water.

10. A water fountain according to claim 9, Wherein aquatic fish tanks the filtration systems can be permanently attached to the back or front of the backboard panel of structures holding water.

11. A water fountain according to claim 10, wherein filtration system consists of two absorbent sponges, lava rocks, or rocks, and stones; and activated carbon that completes the materials for the filtration system.

12. A water fountain according to claim 11, wherein the front face there is a spout that turns the filtrated water to point of origin.

13. A water fountain according to claim 12, wherein the front surface attaches flush against the back panel of the intended structure.

14. A Water fountain according to claim 13, wherein the structure shape curves into a cylindrical rectangle shape.

15. A water fountain according to claim 1, further comprising the function of the water fountain is powered by an electric cord.

16. A water fountain according to claim 15, wherein the operation of the fountain includes a remote multicolored LED light, that is infused with the cord of the water pump.

17. A water fountain according to claim 16, wherein a LED light and the water pump power cord curves through the back panel rear of structure.
